(19) United States
(12) Patent Application Publication
(10) Pub. No.: US 2019/0130448 A1
(43) Pub. Date: May 2, 2019

(54) SYSTEM AND METHOD FOR GENERATING OFFER AND RECOMMENDATION INFORMATION USING MACHINE LEARNING

(71) Applicant: Dinabite Limited, London (GB)

(72) Inventor: Nikolas Kairinos, Limassol (CY)

(21) Appl. No.: 16/158,423

(22) Filed: Oct. 12, 2018

Related U.S. Application Data
(60) Provisional application No. 62/577,823, filed on Oct. 27, 2017.

(51) Int. Cl. G06Q 30/02; G06N 99/00; H04L 29/06

(52) U.S. Cl. CPC G06Q 30/0261; H04L 63/0428; G06N 99/005

(57) ABSTRACT

A system for generating offer and recommendation information, wherein the system includes a machine learning arrangement including data processing hardware for performing data processing, and wherein, when the system is in operation,
the machine learning arrangement accesses an activity log of user activity data obtained from a plurality of sources and analyses the activity log to determine preferences of one or more users;
the machine learning arrangement obtains a list of one or more user devices that are associated with a spatial location of a first type A;
the machine learning arrangement sends recommendations for requests to at least one user device of the one or more user devices associated with the spatial location of the first type A, based on the determined preferences;
the machine learning arrangement obtains details of items from the at least one user device associated with the spatial location of the first type A, when a promotional campaign is launched, wherein the items are chosen based on the recommendations for the requests;
the machine learning arrangement determines a preference of items to which a given user of the one or more users is most likely to respond, based on the given user's activity log;
the machine learning arrangement generates an offer that comprises items that the given user is most likely to respond to, wherein the given user is included in a selected subset of the one or more users;
the machine learning arrangement communicates the offers to the selected subset of the one or more users; and
the machine learning arrangement monitors responses to the offers from the selected subset of the one or more users to improve a determination of the offers.

### TECHNICAL FIELD

The present disclosure relates to systems for generating offer and recommendation information using machine learning; such machine learning involves using artificial intelligence technology. Moreover, the present disclosure relates to methods for (of) using aforesaid system for generating offer and recommendation information using machine learning. Moreover, the present disclosure is concerned with computer program products comprising a non-transitory computer-readable storage medium having computer-readable instructions stored thereon, the computer-readable instructions being executable by a computerized device comprising processing hardware to execute aforesaid methods. Example uses of the systems and methods relate to generating automatically hyper-personalized offers to users and generating intelligent recommendations to restaurants on menu items, pricing, offers and similar; technical advantages provided by the systems and methods of the present disclosure include a reduction in food wastage, an improved user satisfaction and a reduction in quantities of data communicated by the systems to users.

### BACKGROUND

Restaurant review and food delivery software applications (hereinafter “apps”) are contemporarily being employed increasingly by users, wherein a first point of engagement occurs when a given user decides, for example by employing a mobile phone to provide supporting information, to eat at or order food from a restaurant. Restaurants have been using print advertising and marketing collateral to attract customers for many years; however, in the current digital age, the Internet® has been found to be a most effective tool for engaging customers, wherein the customers often have Internet®-enabled smart mobile devices. Restaurants vary greatly in ambience, food choices, and experiences, ranging from inexpensive fast food restaurants and cafeterias to mid-priced family restaurants, to high-priced luxury establishments.

A major challenge in restaurant businesses is a gap between demand and supply; namely, there arises a mismatch between a demand for restaurant services and a supply of restaurant services. Since a primary product that a restaurant offers is food, which is a perishable resource, it is very critical for restaurants both to utilize their existing inventory in real time, as well as effectively to plan for sudden increases or decreases in demand. Thus, restaurants are faced with a challenge of utilizing their fixed costs like rent, personnel, electricity in a most optimal manner. One common strategy used by restaurants is to send promotional offers to users via email, via text messages, and so forth, to attract them to visit to purchase restaurant services. An effectiveness of such promotional campaigns is typically not measurable. Furthermore, such promotional campaigns have a success rate that is hard to link to real-time demand and supply.

Conversely, users potentially feel overwhelmed with offers that are not relevant to them. For example, a given user who is a vegan may receive an offer related to a cheeseburger, or another user may receive a limited period offer from a restaurant in a location that is far away (remote) from the user. Over a period of time, users become “tuned out” (namely insensitive to propositions) and block or stop responding to unwanted notifications and offers.

Therefore, with reference to the foregoing discussion, there exists a need to address, for example to overcome, the aforementioned drawbacks in existing systems, for example used by restaurants, to reach out (namely, to communicate effectively) to customers, as well as via “apps” for users to identify one or more restaurants at relevant locations having items that of interest to the customers that meet their individual requirements.

Known approaches to notify potential users, for example potential restaurant customers, result in unnecessary Internet® data traffic, and can also result in fatigue amongst users who receive an unnecessarily large volume of propositions that need to be assessed. Such fatigue amongst users can result, for example, in headaches, frustration and incorrect decisions being made.

Known state-of-art customer reach out methods are to be regarded as being unidirectional (business-to-consumer) non-feedback methods. As a result, they lack essential features that enable them to iterate and improve.

Thus, the present disclosure is concerned with providing information systems that are more efficient when delivering information to users, thereby saving user fatigue and reducing a volume of data communication that has to be accommodated by data communication networks, for example mobile telephone communication networks (i.e. “cell phone” networks). Moreover, the present disclosure is concerned with providing information systems that, in combination with catering establishment such as restaurants and café s, reduce food wastage. Reducing food waste potentially improves environmental hygiene.

### SUMMARY

According to a first aspect, the present disclosure provides a system for generating offer and recommendation information, wherein the system includes a machine learning arrangement including data processing hardware for performing data processing, and wherein, when the system is in operation,

the machine learning arrangement accesses an activity log of user activity data obtained from a plurality of sources and analyses the activity log to determine preferences of one or more users;

the machine learning arrangement obtains a list of one or more user devices that are associated with a spatial location of a first type A;

the machine learning arrangement sends recommendations for requests to at least one user device of the one or more user devices associated with the spatial location of the first type A, based on the determined preferences;

the machine learning arrangement obtains details of items from the at least one user device associated with the spatial location of the first type A, when a promotional campaign is launched, wherein the items are chosen based on the recommendations for the requests;

the machine learning arrangement determines a preference of items to which a given user of the one or more users is most likely to respond, based on the given user's activity log;

the machine learning arrangement generates an offer that comprises items that the given user is most likely to respond to, wherein the given user is included in a selected subset of the one or more users;

the machine learning arrangement communicates the offers to the selected subset of the one or more users; and

the machine learning arrangement monitors responses to the offers from the selected subset of the one or more users to improve a determination of the offers.

Optionally, when the system is in operation, data communicated between the machine learning arrangement and user devices is implemented via a data communication network arrangement, wherein the communicated data, to improve a data security of the system, is at least one of: encrypted, obfuscated.

Optionally, when the system is in operation, the plurality of sources of activity data is selected from a list comprising at least one of: a current geolocation of a given user, an historical geolocation of a given user, a food preference of a given user, a recorded time-of-day, a recorded day-of-week, a recorded week-of-year, a price range for a given food product.

Optionally, when the system is in operation, the association of the one or more user devices with the spatial location of the first type A is based on a threshold distance between a given user device and the spatial location of the first type A.

Optionally, when the system is in operation, the threshold distance between the given user device and the spatial location is dynamically adjustable.

Optionally, when the system is in operation, the preferences are computed based on a machine learning technique selected from a list comprising: ranking, collaborative filtering, correlation, k-means, Monte Carlo stochastic matching of elements, Kalman filtering, Hamming code filtering.

In the present disclosure, k-means is a partitional based clustering method that finds k clusters from a given dataset by computing distances from each point to k cluster centers, iteratively. A filtering algorithm improves a performance of k-means by imposing an index structure on a dataset and reduces a number of cluster centers searched while finding a nearest center of a point. The performance of the filtering algorithm is influenced by a degree of separation between initial cluster centers. Beneficially, there is employed an efficient initial seed selection method, RDBI, to improve the performance of the k-means filtering method by locating the seed points at dense areas of the dataset and well separated. The dense areas are identified by representing the data points in a kd-tree.

Optionally, when the system is in operation, the offers are improved based on a feedback from the one or more users, wherein the feedback of the one or more users includes actions such as, but not limited to, accepting an offer, rejecting an offer, forwarding an offer to another user.

Optionally, the system, when in operation, generates a plurality of offers associated with a plurality of spatial locations of the first type A, and cross-references the plurality of offers and communicates a subset of the recommendations to one or more user devices associated with a spatial location of a second type B. Optionally, the spatial location of the second type B other types of food delivery establishments that are different to food delivery establishments of the first type B; for example, the first type A includes restaurants and café s, whereas the second type B includes fast-food delivery and mobile snack bars. Optionally, when the system is in operation, the spatial location of the first type A is selected from a list comprising: a restaurant, a canteen, a coffee shop, a shopping mall.

Optionally, when the system is in operation, the machine learning arrangement performs:

automatically generating hyper-personalized offers to users and intelligent recommendations to restaurants;

analysing the activity log of user activity data including analysing the activity log of user food consumption activity data;

determining preferences for users include food, location, language and time preferences for users;

recommending spatial locations including at least one restaurant;

sending recommendations for requests to a device associated with the spatial location including sending recommendations for specials to a restaurant device; and

generating an offer including generating a hyper-personalized curated offer.

More optionally, when the system is in operation, the machine learning arrangement, when in operation, predicts interests in the items of the proximal users based on interests of other similar users, when the activity log is not sufficiently detailed.

Optionally, when the system is in operation, the machine learning arrangement, when in operation using the machine learning to generate the recommendations for the restaurants on pricing, pictures of the menu items, and wording of offers based on the responses to the offers.

According to a second aspect, the present disclosure provides a method for (of) operating the system of the first aspect to generate offer and recommendation information, wherein the system includes a machine learning arrangement including data processing hardware for performing data processing, and wherein the method includes:

using the machine learning arrangement to access an activity log of user activity data obtained from a plurality of sources and analyses the activity log to determine preferences of one or more users;

using the machine learning arrangement to obtain a list of one or more user devices that are associated with a spatial location of a first type A;

using the machine learning arrangement to send recommendations for requests to at least one user device of the one or more user devices associated with the spatial location of the first type A, based on the determined preferences;

using the machine learning arrangement to obtain details of items from the at least one user device associated with the spatial location of the first type A, when a promotional campaign is launched, wherein the items are chosen based on the recommendations for the requests;

using the machine learning arrangement to determine a preference of items to which a given user of the one or more users is most likely to respond, based on the given user's activity log;

using the machine learning arrangement to generate an offer that comprises items that the given user is most likely to respond to, wherein the given user is included in a selected subset of the one or more users;

using the machine learning arrangement to communicate the offers to the selected subset of the one or more users; and

using the machine learning arrangement to monitor responses to the offers from the selected subset of the one or more users to improve a determination of the offers.

Optionally, the method includes implementing a communication of data between the machine learning arrangement and user devices via a data communication network arrangement, wherein the communicated data, to improve a data security of the system, is at least one of: encrypted, obfuscated.

According to a third aspect, there is provided a computer program product comprising a non-transitory computer-readable storage medium having computer-readable instructions stored thereon, the computer-readable instructions being executable by a computerized device comprising processing hardware to execute aforesaid methods of the second aspect.

Embodiments of the present disclosure substantially eliminate or at least partially address the aforementioned problems in existing systems used by organisations (for example, restaurants) to reach out to potential customers, as well as in apps for users to identify more appropriate establishments (for example more suitable restaurants) at the relevant locations having items that of interest to them that meet their individual requirements. Thus, the embodiments of the present disclosure are capable of reducing user fatigue when searching for various establishments in which to seek products and/or services, and is also capable of reducing Internet® data traffic associated with such searching. Devices for reducing user fatigue have been previously subject of patent protection as a technical effect. Moreover, devices for reducing Internet® traffic, for example data encoders and decoders, have frequently been the subject matter of granted patent rights in various countries around the World. Efficiency of utilization of available Internet® bandwidth is a technical effect that is the subject matter of many innovations made by telecommunication infrastructure companies and suppliers that have large portfolios of granted patents.

The present disclosure provides systems and method using the systems that employ non-invasive feedback response mechanisms, that benefit/integrate both restaurant owners' and customers' preferences, hereby reducing food wastage and improving environmental hygiene by avoiding such food wastage.

It will be appreciated that “machine learning” concerns use of one or more algorithms executable on computing hardware arrangement, therein the algorithms iteratively modify their operating parameters depending upon a nature of data being received and/or processed via the algorithms. Optionally, the “machine learning” is implemented as “deep learning”, for example using computing hardware that operates in a manner akin to a hierarchical arrangement of pseudo-analog variable state machines whose pseudo-analog states are varied by parameters that are modified in response to information being processed through the hierarchical arrangement. Such “deep learning” is a closest approach to mimicking a human level of intuition, but in an automated feedback manner. The machine learning arrangement is beneficially implemented using software that executable on computing hardware, on custom-designed digital hardware, or a combination thereof. Digital of the machine learning arrangement is optionally hardware-reconfigurable in response to operating conditions experienced by the system, for example depending upon a quantity of offers, recommendations and acceptances being handled by the system in real-time.

Additional aspects, advantages, features and objects of the present disclosure are made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system for generating hyper-personalized offers to users and intelligent recommendations to restaurants in accordance with an embodiment of the present disclosure;

FIG. 2 is a functional block diagram of a server in accordance with an embodiment of the present disclosure;

FIG. 3 is a functional block diagram of a user device in accordance with an embodiment of the present disclosure;

FIG. 4 is a functional block diagram of a restaurant device in accordance with an embodiment of the present disclosure;

FIG. 5 is an exemplary tabular view that shows an activity log of food related user behaviour and user preferences in accordance with an embodiment of the present disclosure; and

FIGS. 6A and 6B are flow diagrams illustrating a method for automatically generating hyper-personalized offers to users and intelligent recommendations to restaurants in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In an example embodiment, the present disclosure provides a method for (namely, a method of) automatically generating hyper-personalized offers to users and intelligent recommendations to restaurants, the method comprising:

analysing an activity log of user food consumption activity data obtained from a plurality of sources using machine learning to determine food, location, and time preferences for users;

obtaining a list of proximal users who are within a threshold distance from a restaurant at a given time based on locations of user devices;

sending recommendations for specials to a restaurant device based on preferences of the proximal users;

obtaining details of menu items from the restaurant device when the promotional campaign is launched, wherein the menu items are chosen based on the recommendations for the specials;

determining to which of the menu items each of the proximal users are most likely to respond to based on the activity log;

generating a hyper-personalized curated offer that comprises menu items that a user is most likely to respond to, for selected proximal users from the proximal users;

communicating hyper-personalized curated offers to the selected proximal users;

monitoring responses to the hyper-personalized curated offers to provide positive and negative reinforcement as input to the machine learning; and

generating recommendations to the restaurant device on the menu items based on the responses to the hyper-personalized curated offers.

The present method can be used by restaurants to reach out to potential customers. In addition, it helps users to identify relevant restaurants at nearby locations having items that are of interest to them and meet their individual requirements. A restaurant can be any other food provider like canteen, eatery, café, bar, pub etc. The method also helps the restaurants to manage large quantities of excess food items when by providing hyper-personalized curated offers to the users in real time to match the increased supply. The method further improves performance of the restaurants by providing specific suggestions on menu items, pricing, etc. The method further provides only a limited number of relevant hyper-personalized offers to users without annoying them.

In an embodiment, the method may be performed using a server. The server may obtain a food inventory to be campaigned from a restaurant device. The food inventory may comprise a list of menu items (e.g. foods and drinks) available at the restaurant during a particular period of time. The list of menu items may comprise, for example, Meatloaf, shepherd's pie, pot roast and gravy, macaroni and cheese, Burgers, Pizza, Salads, coffee, wine, beer etc. The restaurant device may be a smart phone, a tablet, a laptop or a personal computer etc. The excess food inventory may be prepared by a restaurant admin and communicated to the server during a downtime (e.g. when the restaurant does not meet regular sales targets at a particular time period), when there is a significant cancellation of orders at the restaurant or when the restaurant has over prepared quantities of certain menu items.

The restaurant device may comprise a restaurant device database, a food inventory generating module, a campaign triggering module and recommendations obtaining module, in one embodiment. The food inventory generating module may generate excess food inventory or food inventory to be including in a promotional campaign as an input from the restaurant admin, which may be determined based on a recommended list of menu items from the server. The food inventory generating module may communicate the food inventory to the server. The campaign triggering module may communicate a trigger signal (e.g., at the press of a campaign launch button) to the server to launch the promotional campaign. The recommendations obtaining module may obtain recommendations on menu items, pricing etc. from the server, which are based on machine learning applied on the user activity log, feedback from users in response to hyper-personalized curated offers, etc. The restaurant device database stores food inventory, menu details, current offer details etc.

The server database may store personalized user profiles that comprise preferences, activity, and interest of the users on menu items (e.g. foods and beverages). The personalized user profiles may be filtered based on current locations of the user devices. The personalized user profiles may be selected to recommend the hyper-personalized curated offers when the current location of users is near to a location of the restaurant (e.g. within a threshold radius, walking distance from the restaurant, etc.). The current location of the users may be identified using a Global Position System (GPS) location data, a Wi-Fi positioning system (WPS) location data, and the like. The current location of the users may be identified by ascertaining a position or a location of the user device and by determining whether the user device is stationary or moving based on signals between one or more towers of a mobile operator and the user device when the users disable their GPS. The user device may be a smart phone, a tablet, a laptop a personal computer etc.

In an embodiment, user profiles may be selected based on current locations of the users and preceding preferences of the users at the restaurant. The preceding preferences of the users may comprise a type of menu items previously consumed by the users, a cuisine type selected by the users, an event (e.g. a birthday party, a marriage party or a get-together part etc.) for which the restaurant is preferred by the users, at what time the restaurant preferred by the users (e.g. a time of a day and a day of a week), types of offers selected by the users, types of discounts selected by the users, a price range previously selected by the users and a party size (e.g. a number of people in a group) preferred by the users, language used when communicating the offer (e.g. a user may respond better to the offers with certain wording). For example, the promotional campaign may comprise hyper-personalized curated offers for specific menu items targeting a group of 4, and a particular cuisine type for a specific hour of the day or a specific day of the week for a list of proximal users selected based on their preceding preferences.

The hyper-personalized curated offers are generated using artificial intelligence and machine learning techniques implemented on the server. In an embodiment, the hyper-personalized curated offers are generated by determining menu items that are most likely to get a response from the users based on preceding behaviour and interests of the users on the food and the drinks, preceding days of the week, preceding times of a day, seasons and weather when the users have visited the restaurant and a location where the users received the offer and proceeded to visit the restaurant. In another embodiment, the hyper-personalized curated offers are distinct for each user. The hyper-personalized curated offers may comprise a special discount on specific menu items such as drinks, a combination of food items and beverages, and a specific cuisine type at a particular time of a day etc.

The users may receive the hyper-personalized curated offers that are sorted in order of relevance as notifications to optimize time taken to review the hyper-personalized curated offers. The hyper-personalized curated offers may help the user to make better use of his/her time and financial resources. The method may help the user to make quicker and better decisions about where to eat and what to eat.

The offer notifications are communicated to the users when the current location of the users is within a threshold distance from the restaurant. This may eliminate the generation of irrelevant notifications during irrelevant times. The number of notifications and offers are communicated to the users may be limited to a number that does not exceed a threshold that is determined based on the user's receptiveness to receive similar offers in the past and responsiveness to the offers. When a restaurant launches a promotion, the system sends notifications to the proximal users who are in a closest distance from the restaurant and gradually increases (or decreases if too many notifications are being sent out) the radius based on user responses.

The server may frequently check and fetch new users who have recently entered into an area that is within the threshold radius from the restaurant that has a live campaign who match the set criteria (e.g. whose preferences and interests match with the menu items that are promoted) to generate the hyper-personalized curated offers. The server gradually adjusts the radius based on user reactions, namely the user's acceptance or rejection of the offer.

The offers may comprise special discounts, percentage discounted offers for specific menu items at a particular period of time, special cash back for specific menu items at a particular period of time, items for free, meal vouchers, free delivery above a certain amount spend in restaurant or a special deal for the specific menu items at a particular period of time and others. The system will also learn about user preferences for the type of special offer and recommend accordingly.

In an embodiment, a threshold level number of the recommendations for restaurants and the hyper-personalized curated offers generated for the users may vary for each campaign.

The recommendations and the hyper-personalized curated offers may be accepted by swiping right or ignored by swiping left or passed to another user who may be interested in this offer by swiping up.

Depending on the user's reaction, namely whether the offer is accepted and responded to, or ignored, or depending on feedback received from the user on an offer, the machine learning algorithm receives positive reinforcement or negative reinforcement, and it is trained to generate more relevant offers in the future. The user interacts with each of the offers (even if it is by ignoring it) to provide positive or negative reinforcement to the system. The system stores all types of responses (reactions).

The machine learning techniques may generate hyper-personalized curated offers for the personalized users based on the user's interaction with the mobile application or notifications (e.g. the hyper-personalized curated offers) communicated to the users. It may analyze the user's interaction with the mobile application or notifications to establish how likely the users are interested to receive more of the hyper-personalized curated offers and how receptive each user is. Regarding this feature radius may adjust numbers of sent offers to particular user.

A campaign may be launched by the restaurant admin using one click. The restaurant admin may set a threshold when the campaign needs to be launched. The campaign may be launched and stopped by tapping a button. The campaigns are typically not launched in regions where there is no critical mass of users.

In an embodiment, the campaign is launched after generating the hyper-personalized curated offers for the users using the machine learning. In another embodiment, the machine learning identifies the users and generates the hyper-personalized curated offers for each of the users after the campaign is launched.

The personalized user profiles are updated by the machine learning based on the responses and the interest of the users on the hyper-personalized curated offers. For example, the machine learning updates the personalized user profiles with whether the users have accepted the offer or not and positive and negative responses (e.g. the offer was good and menu items are delicious or pricing range for the menu items somewhat high etc.) of the users towards the offers provided to the users. The personalized user profiles may be updated using the machine learning constantly based on multiple data points.

The machine learning may provide recommendations on restaurant menu items based on various data points gathered per user, per restaurant, per meal and per location etc. In an example, a recommendation to a restaurant may include “if you add a lactose free burger to the restaurant menu, you are most likely to see an 8% growth in the numbers of orders per week”. The machine learning may provide recommendations on restaurant menu items based on preference of the users on restaurant menu items. In another example, if a particular menu item is not preferred by the users, the machine learning may provide recommendations to reduce a price range for the particular menu item, to replace it, offer it at a different time, or to remove the menu item from the restaurant menu. The machine learning may provide recommendations for upcoming campaigns based on the behaviour and interest of the users on previous campaigns. In an example, if the previous campaigns didn't perform well for a specific user, the machine learning component may provide a recommendation to change menu items offered to the user, reduce the price range, change the time of the offer, etc.

The machine learning techniques may provide recommendations on the menu items via a platform or a mobile application by aggregating the multiple data sources (e.g. the user data and the preferences and the interest of the users), service solutions (e.g. delivery services of the restaurant, booking services of the restaurant), discounts and special offers (e.g. vouchers and coupons).

According to an embodiment, the method further includes automatically generating hyper-personalized offers to users and intelligent recommendations to restaurants;

analysing the activity log of user activity data includes analysing the activity log of user food consumption activity data;

the determined preferences for users include food, location, language and time preferences for users;

the spatial location includes a restaurant;

sending recommendations for requests to a device associated with the spatial location includes sending recommendations for specials to a restaurant device;

the items include menu items;

the requests include specials; and

generating an offer includes generating a hyper-personalized curated offer.

According to an embodiment, the method further comprises predicting interests in the menu items of the proximal users based on interests of other similar users, when the activity log is not sufficiently detailed. The hyper-personalized curated offers may be recommended to new users based on analysis of behaviour and interest of the similar users.

According to another embodiment, the hyper-personalized curated offer is personalized and worded according to the preferences of the user.

According to yet another embodiment, the hyper-personalized curated offer is communicated to the user based on a confidence factor on user interest in a menu item at a particular time in a day at a restaurant, based on previous food consumption of the user, pricing ranges of menu items that are previously preferred by the user, and how the user responded to previous offers. The confidence factor comprises how likely the users are interested to have a particular menu item at a particular time in a day. The confidence factor may be a score that is generated using a machine learning algorithm based on comparison of the menu items associated with the food inventory with preferences and interest of the user on the menu items that are associated with the personalized user profiles.

The machine learning algorithms may compare the menu items associated with the food inventory with the preceding behaviour and interests of the users to determine the confidence factor for each user. The hyper-personalized curated offers may be generated for each user based on their confidence factor on user's interest in a menu item at a particular time in a day at a restaurant. In an example, if the food inventory comprises pizza and burgers as menu items, the personalized user profiles are analyzed to identity proximal users who are all previously ordered the pizza and burgers at the restaurant.

The machine learning may generate the hyper-personalized curated offers for the proximal users who are all previously ordered the pizza and the burgers and who are all accepted and benefited from previous hyper-personalized curated offers. The user's interest on previous hyper-personalized curated offers (e.g. whether a user has accepted and benefited from the offer or ignored the offer) is analyzed to recommend a new hyper-personalized curated offer to the user. In another example, if the user always orders something with mushrooms, only the offers containing menu items as mushrooms are recommended to the user.

In another example, if a new user ordered a burger and/or pizza in his/her first visit to the restaurant, and the campaign comprises pot roast and gravy, macaroni and cheese with the offer, the machine learning may analyse the personalized user profiles as to whether any of the users ordered the pizza and burger in their first visit to the restaurant and ordered pot roast and gravy or macaroni and cheese in any of their subsequent visits to the restaurant. The machine learning may analyse the preferences and interest of the user who have ordered the pot roast and gravy or macaroni and cheese in any of their subsequent visits to generate the hyper-personalized curated offer for the new user. Similarly, the server may recommend menu items to new users based on menu items preferred by similar users. The machine learning may be implemented in a server to generate the hyper-personalized curated offers for each user based on their preferences and interest on the menu items at the restaurant.

According to yet another embodiment, the method further comprises using the machine learning to generate recommendations on pricing, pictures of menu items, and wording of offers based on the responses to the hyper-personalized curated offers.

In an embodiment, the machine learning generates recommendations on upcoming campaigns comprising new menu items to be included to improve restaurant menus and to attract the users on the hyper-personalized curated offers. The recommendations on upcoming campaigns may be generated based on a performance of previous campaigns. The machine learning may provide recommendations on offer wording (e.g. a language) of the hyper-personalized curated offers per user to adjust to the preferences of the user. In an example, the machine learning may provide recommendations for different users, for example, “hey Jack, hit the restaurant next doors for the yummy Katsu Curry” and “Dear Robert, would you like to try the latest special from the Browns restaurant?” The machine learning may calculate a bill for menu items associated with a campaign based on a number of users identified for offer generation or a number of the hyper-personalized curated offers to be generated for the campaign.

In an embodiment, the hyper personalized user profiles are generated by obtaining user data and preferences and actions on the menu items (e.g. which menu items they tap on and what they order for delivery, etc.). The user may specify their preferences by completing a form or stating their interest on the food and the drinks etc. using the user device. The user device may track the preferences of users on foods and drinks at the restaurant by analyzing an activity log that includes behaviour of the users and communicate it to the server.

The user device may comprise a user device database, a user preference obtaining module, a content gathering module, an activity analysis module, an implicit profile generation module, an offer shifting module and a receptiveness monitoring module, in one embodiment. The user preference obtaining module may obtain preferences (e.g. user defined preferences) of the users on menu items. The user preference obtaining module may obtain user data from the users. The user data may comprise a name of a user and contact details of the user (e.g. a phone number and an address of the user etc.) etc. The content gathering module may access content from different resources (e.g. food booking apps, restaurants booking apps, food deliver apps and vouchers previously used by the users) by analysing the user's activity on applications associated with the different resources using the user device. User data and preferences are stored in an anonymized encrypted manner that protects user's privacy. The user's identities or any other personal data cannot be accessed unless the user has accepted the offer. The activity analysis module may analyse which menu item the user likes, when the user prefers to have that menu item and at which restaurant the user prefers to have that menu item. In an example, a user may tend to order pizza when it rains and curry after working long hours etc. The preferences of the users may be different when they are at home as compared to when at work. The activity analysis module may analyse activities of the users on the restaurant menu to identify the preferences of the users. The activity analysis module may analyse the detailed activity log of the users to identify the individual preferences of the users.

The implicit profile generation module may generate a profile for each user with the user data and the preferences (e.g. the user defined preferences and the preference identified based on user activities on the restaurant menu) of each user on the foods and the drinks. The offer shifting module may allow each user to refer or transfer a hyper-personalized curated offer to another user (e.g. a friend) when the user in not interested and find that the offer is more relevant to his/her friend. The receptiveness monitoring module may monitor behaviour of the users (e.g. whether the users have read the notifications associated with the hyper-personalized curated offers or not) with respect to the notification associated with the hyper-personalized curated offer. The user device database may store the personalized user profiles and hyper-personalized curated offers.

In an embodiment, the user device provides unique user interfaces to the users to obtain user data from the users and to display the hyper-personalized curated offers to the users.

According to an embodiment, the threshold distance from a spatial location at a given time is adjusted based on the responses to the offers.

According to another embodiment, a rate at which the offers are communicated to the selected proximal users is adjusted based on the responses to the offers.

Not every user in the threshold distance from the spatial location receives an offer immediately. The system gauges how many offers are being accepted or rejected or passed to another user and adjust the rate at which offers are being sent out accordingly. The system performs this task in conjunction with adjusting the threshold distance from the spatial location.

Embodiments of the present disclosure used to improve the restaurant management through responses and interest of the users on the menu items of a campaign. Embodiments of the present disclosure further used to recommend the highly relevant and suitable menu items for users and new users. Embodiments of the present disclosure further help to improve management of restaurant resources such as personnel, energy and rent. Embodiments of the present disclosure further help the restaurant to improve the sale during downtime by providing the hyper-personalized curated offers to the users. Embodiments of the present disclosure further reduce the food wastage and improve efficiency of the restaurant management.

### DETAILED DESCRIPTION OF THE DRAWINGS

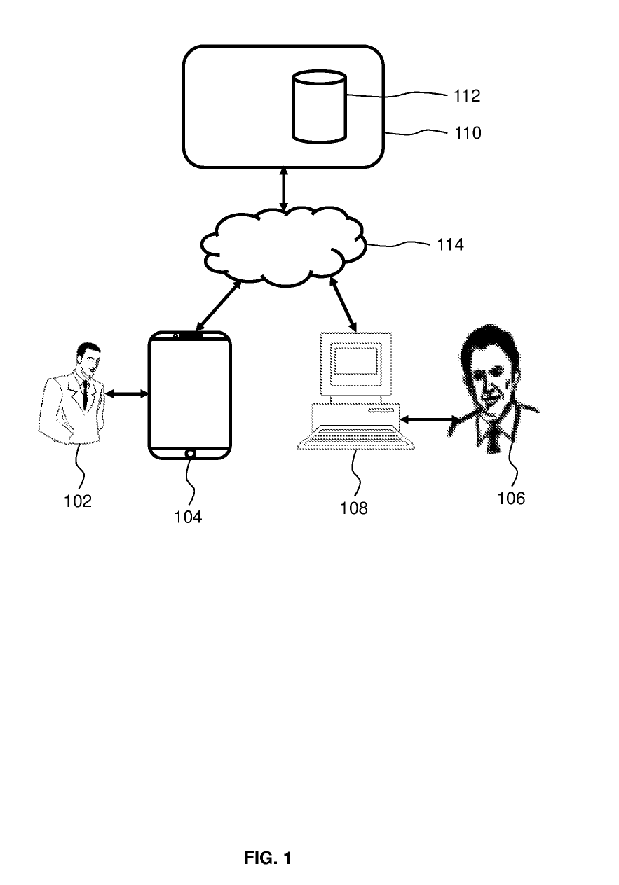

FIG. 1 is a schematic illustration of a system for automatically generating hyper-personalized offers to users and intelligent recommendations to restaurants in accordance with an embodiment of the present disclosure. The system comprises a user 102, a user device 104, a restaurant admin 106, a restaurant device 108, a server 110 and a network 114. The user 102 specifies his preferences on menu items though the user device 104. The restaurant admin 106 generates a food inventory comprising menu items that are available for sale using the restaurant device 108. The food inventory is communicated to the server 110 through the network 114. The server 110 generates a personalized user profile for the user 102 by analysing an activity log of user food consumption activity data obtained from a plurality of sources using machine learning. The server 110 comprises a server database 112 that stores personalized user profiles and the activity log of the user 102. The server 110 sends recommendations for specials to the restaurant device 108 based on preferences of proximal users. Once a promotional campaign is launched by the restaurant admin 106 using the restaurant device 108, the server 110 obtains details of menu items from the restaurant device 108 and determines which of the menu items which of the proximal users is most likely to respond to based on the activity log. The server 110 generates a hyper-personalized curated offer that comprises menu items that a user is most likely to respond to, for selected proximal users from the proximal users. The server 110 communicates hyper-personalized curated offers to the selected proximal users who are around the restaurant at a walkable distance, according to user's reactions for specific offers radius of promotions will adjust the rate. The server 110 updates the personalized user profiles by monitoring responses to the hyper-personalized curated offers to provide positive and negative reinforcement as input to the machine learning. The server 110 generates recommendations to the restaurant device 108 on the menu items based on the responses to the hyper-personalized curated offers.

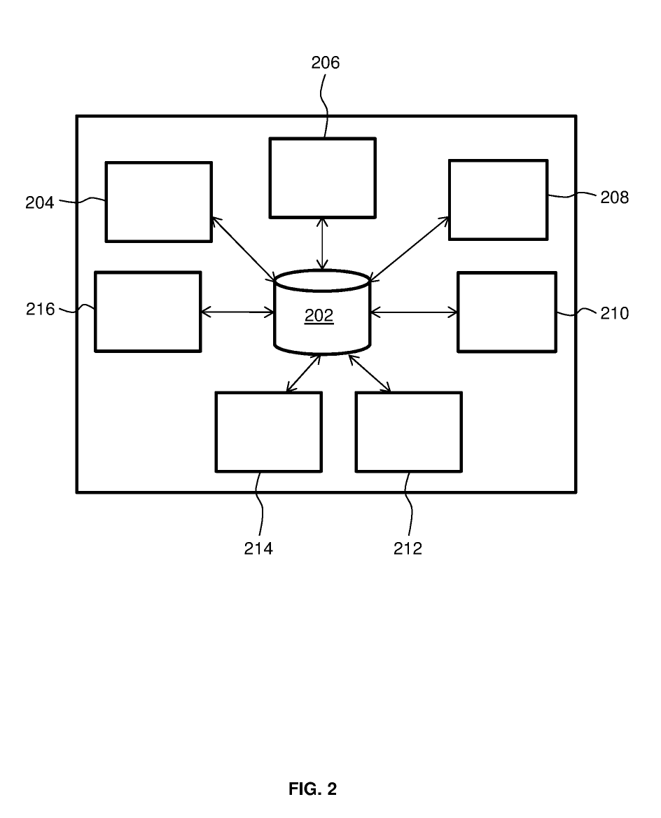

FIG. 2 is a functional block diagram of a server in accordance with an embodiment of the present disclosure. The server comprises a server database 202, a food inventory obtaining module 204, a collaborative filtering module 206, a targeted user identifying module 208, a personalized offer generating module 210, a campaign launching module 212, a user profile updating module 214 and a recommendation module 216. The food inventory obtaining module 204 obtains a food inventory comprises menu items that are available at a restaurant for a particular period of time from a restaurant device. The collaborative filtering module 206 analyses an activity log of user food consumption activity data obtained from a plurality of sources using machine learning to determine food, location, language and time preferences for users. The collaborative filtering module 206 obtains a list of proximal users who are within a threshold distance from a restaurant at a given time based on locations of user devices from the server database 202. The server sends recommendations for specials to a restaurant device based on preferences of the proximal users and obtains details of menu items from the restaurant device to launch a promotional campaign. The menu items are chosen based on the recommendations for the specials. The targeted user identifying module 208 identifies selected proximal users by determining which of the menu items which of the proximal users is most likely to respond to based on the activity log. The personalized offer generating module 210 generates a hyper-personalized curated offer that comprises menu items that a user is most likely to respond to, for the selected proximal users from the proximal users. The campaign launching module 212 launches the promotional campaign by communicating hyper-personalized curated offers to the selected proximal users. The user profile updating module 214 monitors responses to the hyper-personalized curated offers to provide positive and negative reinforcement as input to the machine learning. The recommendation module 216 generates recommendations to the restaurant device on the menu items based on the responses to the hyper-personalized curated offers. The server database 202 comprises the activity log of the users, the hyper-personalized curated offers generated for the users, restaurant menus, the recommendations on the restaurant menu items and the recommendations on the promotional campaign.

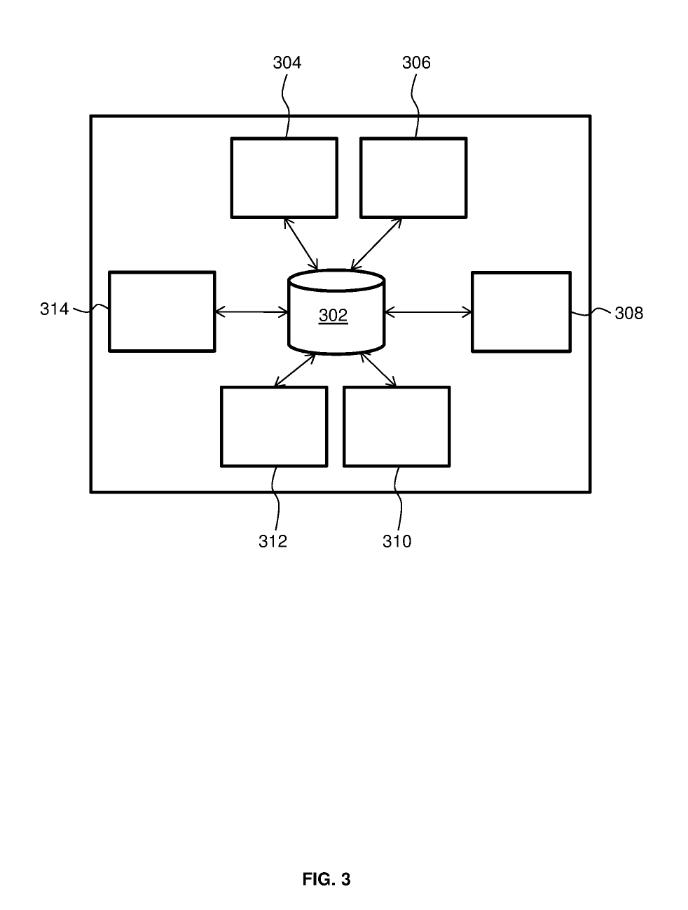

FIG. 3 is a functional block diagram of a user device in accordance with an embodiment of the present disclosure. The user device comprises a user device database 302, a user preference obtaining module 304, a content gathering module 306, an activity analysis module 308, an implicit profile generation module 310, an offer shifting module 312 and a receptiveness monitoring module 314. The functions of these parts as have been described above.

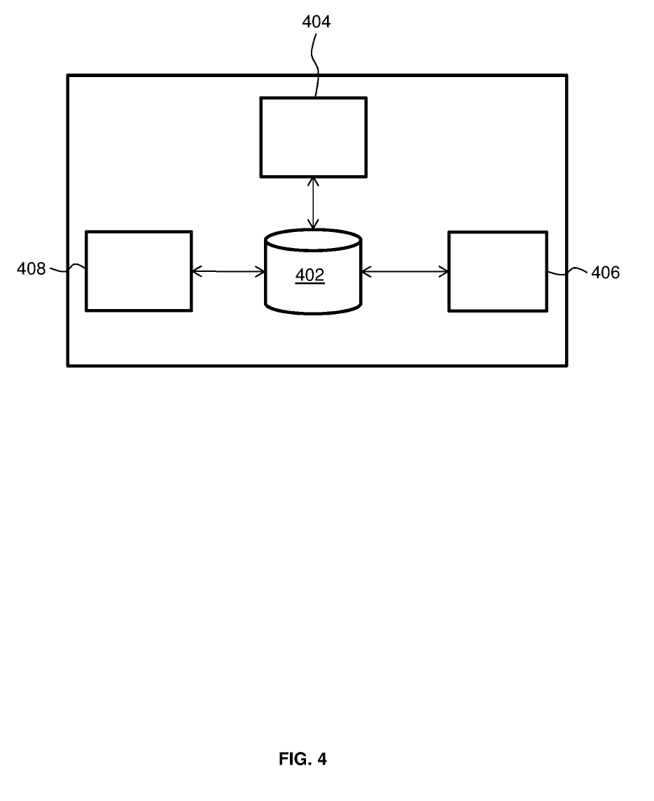

FIG. 4 is a functional block diagram of a restaurant device in accordance with an embodiment of the present disclosure. The restaurant device comprises a restaurant device database 402, a food inventory generating module 404, a campaign triggering module 406 and recommendations obtaining module 408. The functions of these parts as have been described above.

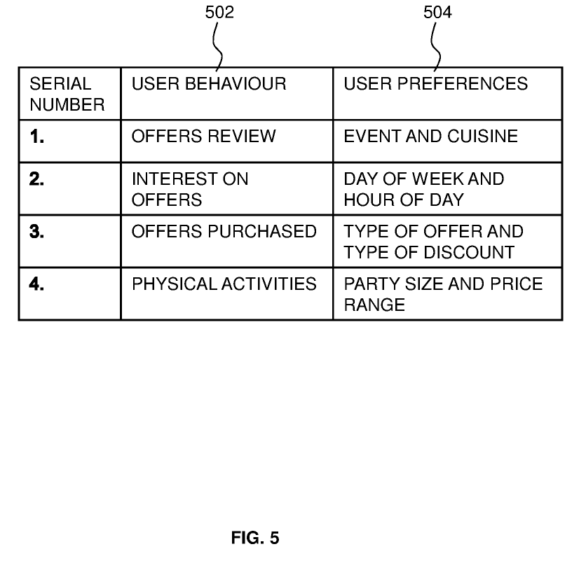

FIG. 5 is an exemplary tabular view that shows an activity log of food related user behaviour and user preferences in accordance with an embodiment of the present disclosure. The tabular view comprises a user behaviours field 502 and a user preferences field 504. The user behaviours field 502 shows a behaviour of users (e.g. John Doe, Jane Reed, Jack Smith and Alice Williams) on the restaurant menus and the hyper-personalized curated offers that are provided to the users. The user behaviour comprises a hyper-personalized curated offers review, interest on the hyper-personalized curated offers (e.g. which of the hyper-personalized curated offer is more interested to a user), whether the hyper-personalized curated offers are purchased or not and physical activities comprising a day and a time at which the user previously visited a restaurant, a distance that travelled by the user to visit the restaurant, a time spend by the user in the restaurant etc. The user preferences field 504 shows user preferences comprising a cuisine and an event type that is preferred by the user, a day of a week and a time of a day that is preferred by the user, a type of offer or a type of discount that is preferred by the user, a party size and a prince range of menu items that are preferred by the user.

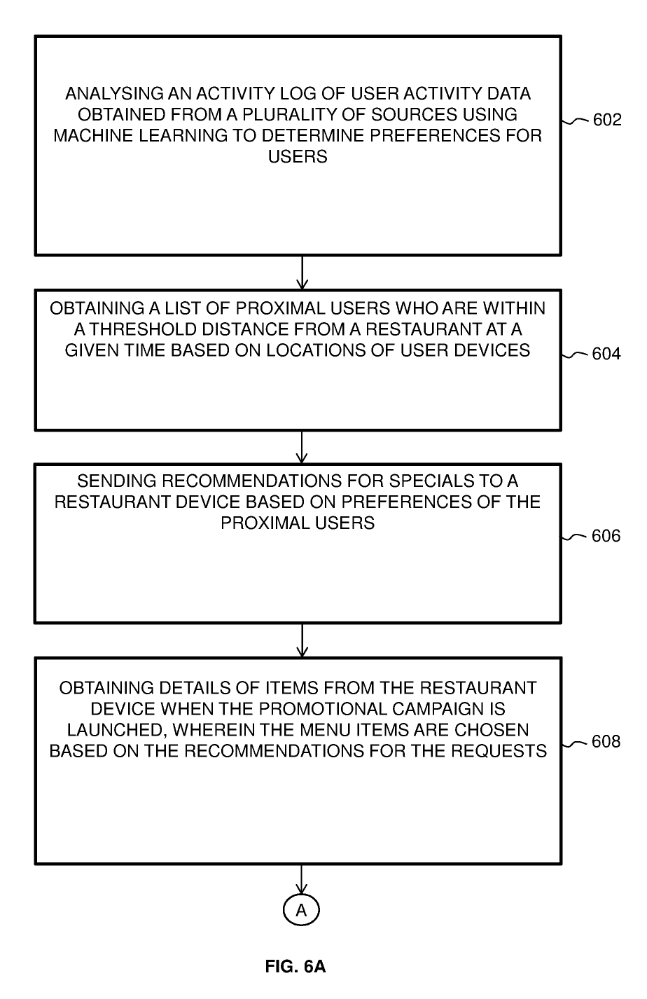

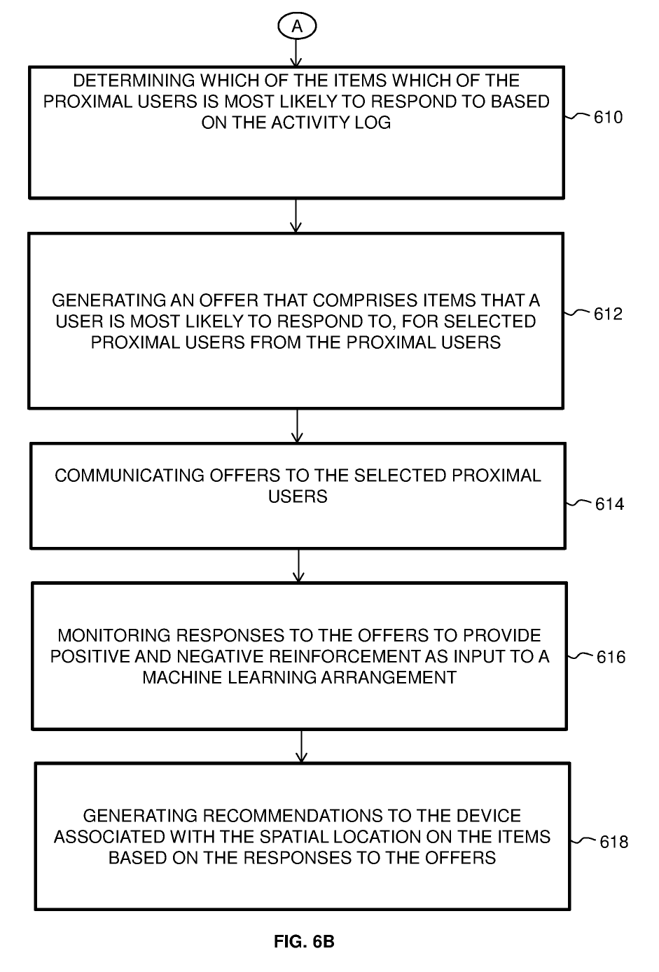

FIGS. 6A and 6B are flow diagrams illustrating a method for automatically generating hyper-personalized curated offers to users and intelligent recommendations to restaurants in accordance with an embodiment of the present disclosure. At a step 602, an activity log of user food consumption activity data obtained from a plurality of sources is analysed using machine learning to determine food, location, language and time preferences for users. At a step 604, a list of proximal users who are within a threshold distance from a restaurant at a given time is obtained based on locations of user devices. At a step 606, recommendations for specials are sent to a restaurant device based on preferences of the proximal users. At a step 608, details of menu items from the restaurant device are obtained when the promotional campaign is launched, wherein the menu items are chosen based on the recommendations for the requests. At a step 610, which of the menu items which of the proximal users is most likely to respond to are determined based on the activity log. At a step 612, a hyper-personalized curated offer that comprises menu items that a user is most likely to respond to is generated for selected proximal users from the proximal users. At a step 614, hyper-personalized curated offers are communicated to the selected proximal users. At a step 616, responses to the hyper-personalized curated offers are monitored to provide positive and negative reinforcement as input to the machine learning. At a step 618, recommendations to the restaurant device associated with the spatial location on the menu items are generated based on the responses to the hyper-personalized curated offers.

Although embodiments of the disclosure described in the foregoing relate to restaurants, it will be appreciated that embodiments of the disclosure can relate to materials supply for manufacturing industry, supply of services and equipment for construction industries, and similar. Such uses of embodiments of the present disclosure clearly pertain to industrial applications and uses (namely, the embodiments are industrially applicable).

With reference to the aforesaid system of FIG. 1, the system employs a method of operation that, for example, provides the hyper-personalised curated offers that extend to users in non-proximal areas (B-type regions). The non-limiting examples of the system described in the foregoing serve to illustrate that the method is not limited to just a single user, but can pertain to a plurality of users.

When the system of FIG. 1 is in operation, a given user U(A) is associated with features. (comprising a geolocation feature, eating habits features and so forth) wherein the features include eating habits that further comprise a user-preferred eating time or an eating time window and a set of preferred cuisines. A hyper-personalised generation system of the system of FIG. 1 first scans within a radius, denoted by R1, for a set of users of a first type A, within the radius R1, wherein each user is identified using their geolocation feature and their preferred set of cuisines.

Furthermore, the system will also scan for the available cuisines within the radius R1, producing a list of available cuisines within R1, wherein the list is denoted by L1. The system then adjusts the scan radius to another range, say to a radius R2. Using the adjusted radius R2, the system then scans for a set of available cuisines, producing a list of available cuisines within the radius R2, wherein the list is denoted by L2. The system next compares the lists of cuisines, namely L1, L2, and produces a list identifying differences between the two lists, namely L1, L2, where the difference implies cuisines present in the list L2 but not in the list L1.

The system will then compare the set of users U(A) that match cuisines from the difference set. Moreover, the system will then initiate a campaign to users for catering cuisine via a food delivery method. In a preferred embodiment the radius R2 is less than the radius R1. In another preferred embodiment of the present disclosure, both the radius R2 is less than the radius R1, and the catering of the cuisine in a delivery method. In another preferred embodiment of the present disclosure, the present example is combined with other machine learning methods described herein.

Next, use of the system to determine a best time to send an offer for a given food product will be described. In an embodiment, a part of the user-preferred features includes a preferred time of eating. As such, the aforementioned, a given hyper-personalised offer of the system is sent within a user specific time window.

At a beginning, the system is agnostic of a preferred eating time of a given user. As such, the system initiates a campaign in a time-agnostic manner and the offers are then sent within a time window that is a universally accepted period of time that relates to an eating time period (for example, in a time period of 12:00 hrs to 13:00 hrs). If the user does not respond to the received offer, then another period of time is chosen to send offers (for example, in a time period of 13:00 hrs to 14:00 hrs). Such aforesaid periods of time optionally change in a non-periodic manner in such a way that the different time-of-day periods are sampled and different responses (for example, acceptance or rejection) are recorded for the different time-of-day periods.

As the given user accepts offers, the time of acceptance of the offers is recorded and a time-of-acceptance profile is built up within the system, for example within a database arrangement of the system. In an example embodiment, the time of acceptance profile is a distribution of accepted offer times. The distribution can be further described using statistical measures such as a mean, a median, a mode of the distribution, and relevant dispersion metrics thereof. Suggested times to generate offers to send to the given user are then obtained (namely computed), based on the statistical measures of the distribution that describe the preferred user eating time.

In one example embodiment, the time-of-acceptance profile is built using all available data relating to time-of-acceptance in the given user's history. In another example embodiment, a random (namely, stochastic) sampling of all available data is used to build the profile. In yet another example embodiment, the user acceptance profile is built using a latest time that the user has accepted a given offer.

Next, use of the system of FIG. 1 for determining a preferred cuisine (category of food) for a given user will be described.

In an example embodiment of the present disclosure, the user's profile is associated with a history of accepted offers. In this history of accepted offers, the system identifies (namely computes) a most common (namely, most frequently occurring) set of choices, denoted by “C”, during a first time period, denoted by “x”, and a least common (namely, least frequently occurring) set of choices, denoted by “D”, during a second time period, denoted by “y”. The system of FIG. 1 then generates offers based on a method, wherein the method utilizes parameters as follows:

the time period x;

the set of choices C within time period x;

the time period y; and

the set of choices D within time period y.

In a preferred embodiment of the present disclosure, when implementing the aforementioned method, the first time period, x, is greater than the second time period, y. In one example embodiment, the given user's activity of a latest month is described by the user-accepted offers, wherein the user-accepted offers include a type of cuisine that is acceptable to the given user. Based on a statistical method, such as a ranking method, although other statistical methods such as aforementioned can be employ for example, one or more most popular user-preferred cuisines of the user are ranked, producing a ranked list X1. The system of FIG. 1 then performs a likewise identification of cuisines for the second time period, y, producing a set of preferred cuisines for the given second time period creating a ranked list based on a user-specific feature, such as user offer acceptance, creating a ranked list Y1.

In the system of FIG. 1, when in operation, the two ranked lists X1 and Y1 are compared using data processing hardware, for example implementing machine learning, and a choice is made based on differences between the two lists X1 and Y1. For example, when making the comparison, the choices identified as those within the 10^{th} percentile of the list X1 (namely, the most popular choice or choices of the list) are compared with the choices identified by the 90^{th} percentile of the list Y1 (namely, the least popular choice or choices of the list), and the user offer generated therefrom is based on commonalities between the two percentiles.

As such, the system of FIG. 1 generates offers based on users' activities and what users have not consumed lately. For example, the first time period, x, is optionally the latest month of user activity whereas the second time period, y, is the latest week of user activity, and the generated offer therefrom is based on identifying the user's most common (namely, most frequently occurring) choice of the last month that has not been consumed during the past week.

Next, using the system of FIG. 1 to determine a given user's lifestyle and cuisine will be described in greater detail.

In an example embodiment of the present disclosure, a part of a decision mechanism employed in data processing hardware employed to implement the system of FIG. 1 concerns a user life-style. In other words, a part of the user features comprises also a user life-style. The user life-style is optionally a qualitative feature of the user such as, but not limited to, a user who is a physical exercise enthusiast. For example, a given user's “apps” (namely, software applications loaded onto a portable computing device of the given user) and preferred food activity patterns of the given user (namely, types of food consumed by the given user as a function of time) can be used to suggest to other users having same “apps” downloaded to their personal computing devices and having the same food activity patterns.

In an example embodiment, a given user's life-style is determined (namely computed) by performing a poll of one or more “apps” present on the given user's portable computing device, for example smart phone, tablet computer, personal digital assistant (PDA) and so forth. In an example embodiment of the present disclosure, the user's “apps” are identified by the system to be a most active type of “apps” in terms of usage on the given user's smart phone over a current period of time. The “apps” will then provide a basis to form features that describe the given user. Furthermore, the given user can also be identified with a set of preferred cuisines based on the user's activity of offer-acceptance, for example as aforementioned. A double optimisation method can be used to identify the user's features, where the features comprise a combination of the user “apps” present on the user device, and common (namely, most frequently occurring) food choices.

As such, the method of using the system of FIG. 1 enables suggesting to various users a set of preferred cuisines by examining the users' preferred “apps”. In an example embodiment, a double optimisation method includes use of a collaborative filtering algorithm. In the collaborative filtering algorithm, the system of FIG. 1 optimises preferred cuisines based on a set of current and existing users and the applications (“apps”) used on their personal computing devices, wherein the method includes using such information to generate offers for users that have not used the system beforehand, based on the existence of same or related “apps” on their personal computing devices, for example smart phones.

Next, use of the system of FIG. 1 to determine food variability will be described in greater detail.

In one example embodiment of the present disclosure, hyper-personalised offers generated by the system of FIG. 1 are made in such way, so as to reduce, for example to minimize, competition within a neighbourhood of competing restaurants.

Once the offer generation mechanism is initiated, the system of FIG. 1 polls the neighborhood for existing competing restaurants. The neighborhood is, for example, defined by a dynamically adjusted radius, for example as aforementioned. The similar restaurant offers are then compared and the system of FIG. 1 presents the option of a differentiated menu to each restaurant to users.

In one example embodiment of the present disclosure, competing businesses, for example competing restaurant businesses, are beneficially classified using a k-means type of analysis, for example as aforementioned, implemented in machine learning software or digital hardware or a combination thereof. Classification features for implementing the analysis optionally include geolocation data, business hours data, menu items data that are available, pricing data, cuisine data, customer demographics data, but not limited thereto. One or more inventories of the businesses are optionally compared, and suggestions based on menu composition are made. For example, two competing restaurants have offers for the same special (food product). For example, both restaurants have offers based on Italian cuisines. The system of FIG. 1 then generates offers for the restaurants that are mutually differentiated. For example, the system of FIG. 1 generates an offer for one restaurant for a type of pizza, for example a pizza margarita, and for another restaurant has an offer on a pasta, for example a pasta marinara.

Aforementioned example embodiments of the system of FIG. 1 will next be summarized, in conclusion, for providing an overall appreciation of the system.

In operation of the system of FIG. 1, each user (for example, a given customer) of the “app”, is associated with a profile built (namely, constructed) by the system if FIG. 1. The profile includes features of food preference, geolocation and eating time, price range. From a business owner's point of view, the system of FIG. 1 polls the vicinity of the neighberhood and data is gathered on the eating habits of potential customers. Next, the system recommends to the business owner what type of specials should appear based on the nearby potential customers. Thereafter, the suggested items are approved by the business owner (for example, based on current stock). The system of FIG. 1 then sends out suggestions based on the approvals of the owner. Finally, the system of FIG. 1 improves its manner or operation, for example optimizes its manner of operation, using machine learning algorithms, based on feedback from the customers for the suggestions. Specifically, the suggestions pertain to offers being approved, ignored or forwarded to a friend, for example.

It will be appreciated that security of user data, likewise supplier data, in the system of FIG. 1 is very important to protect, for example against third party malicious attacks that could potentially disrupt operation of the system and abuse its data. It is therefore desirable that communication to “apps” implementing embodiments of the present disclosure, wherein the “apps” are executed on users' devices, is performed in a robust manner that is less vulnerable to such third-party malicious attacks. Optionally, data communicated within the system of FIG. 1 is encrypted at sending and decrypted at receipt, for example offers and user responses to such offers; likewise, geolocation information sent to the system of FIG. 1 from users' devices is also encrypted when sent, and decrypted at data processing hardware of the system that implements the aforementioned machine learning algorithms, when received. For example, the system beneficially utilizes private-public key encryption for such communication, although other encryption approaches are alternatively employed, for example data obfuscation achieved by selective swapping of bits of data bytes, or sequences of data bytes in data blocks. When an exceptional degree of data security is required in the system of FIG. 1, a combination of encryption and data obfuscation is employed in the system when sending data, wherein a data map is employed to describe encryption and obfuscation employed, wherein the data map when communicated within the system is also encrypted and/or obfuscated for enhanced data security, and wherein the data map is used to de-obfuscate and then decrypt data at receipt. A combination of encryption and obfuscation is exceptionally robust to unauthorized eavesdropping, even to governmental “police state” spying organisations with supercomputing or quantum computing resources at their disposal. As aforementioned, data encryption/decryption or data obfuscation, or both, employed within the system of FIG. 1 is beneficially dynamically reconfigurable in its operating parameters (for example, using nested encryption/decryption) so that digital hardware of the system of FIG. 1 is dynamically reconfigurable depending a degree of third-party malicious eavesdropping attack experienced by the system of FIG. 1.

In an example embodiment of the system of FIG. 1, the system stores all types of responses, for example received from users. In another example embodiment of the system of FIG. 1, the system stores only a latest number of such responses, for example only responses received within a past month, more optionally within a past two weeks, more optionally within a past week, and yet more optionally within a past couple of days. In yet another embodiment of the system of FIG. 1, the system does not preferences provided by aforesaid responses, but uses a current selection of user preferences to improve (for example, to optimize) a given user profile and then erases from data memory of the system data relating to the preferences. The advantage of such an operating feature is that it reduces an amount of data that the system has to have stored on its database. Moreover, Moreover, in an event of the system of FIG. 1 being “hacked” by a malicious third-party, deleting such supporting data of preferences and responses resulting in an improvement a given user profile results in there being less personal data on the system, thereby improving user confidentiality and related personal data.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for generating offer and recommendation information, wherein the system includes a machine learning arrangement including data processing hardware for performing data processing, and wherein, when the system is in operation,
the machine learning arrangement accesses an activity log of user activity data obtained from a plurality of sources and analyses the activity log to determine preferences of one or more users;
the machine learning arrangement obtains a list of one or more user devices that are associated with a spatial location of a first type A;
the machine learning arrangement sends recommendations for requests to at least one user device of the one or more user devices associated with the spatial location of the first type A, based on the determined preferences;
the machine learning arrangement obtains details of items from the at least one user device associated with the spatial location of the first type A, when a promotional campaign is launched, wherein the items are chosen based on the recommendations for the requests;
the machine learning arrangement determines a preference of items to which a given user of the one or more users is most likely to respond, based on the given user's activity log;
the machine learning arrangement generates an offer that comprises items that the given user is most likely to respond to, wherein the given user is included in a selected subset of the one or more users;
the machine learning arrangement communicates the offers to the selected subset of the one or more users; and
the machine learning arrangement monitors responses to the offers from the selected subset of the one or more users to improve a determination of the offers.

2. The system of claim 1, wherein data communicated between the machine learning arrangement and user devices is implemented via a data communication network arrangement, wherein the communicated data, to improve a data security of the system, is at least one of: encrypted, obfuscated.

3. The system of claim 1, wherein the plurality of sources of activity data is selected from a list comprising at least one of: a current geolocation of a given user, an historical geolocation of a given user, a food preference of a given user, a recorded time-of-day, a recorded day-of-week, a recorded week-of-year, a price range for a given food product.

4. The system of claim 1, wherein the association of the one or more user devices with the spatial location of the first type A is based on a threshold distance between a given user device and the spatial location of the first type A.

5. The system of claim 1, wherein, when in operation, the threshold distance between the given user device and the spatial location is dynamically adjustable.

6. The system of claim 1, wherein the preferences are computed based on a machine learning technique selected from a list comprising: ranking, collaborative filtering, correlation, k-means, Monte Carlo stochastic matching of elements, Kalman filtering, Hamming code filtering.

7. The system of claim 1, wherein the offers are improved based on a feedback from the one or more users, wherein the feedback of the one or more users includes actions such as, but not limited to, accepting an offer, rejecting an offer, forwarding an offer to another user.

8. The system of claim 1, wherein the system, when in operation, generates a plurality of offers associated with a plurality of spatial locations of the first type A, and cross-references the plurality of offers and communicates a subset of the recommendations to one or more user devices associated with a spatial location of a second type B.

9. The system of claim 1, wherein the spatial location of the first type A is selected from a list comprising: a restaurant, a canteen, a coffee shop, a shopping mall.

10. The system of claim 1, wherein the machine learning arrangement performs when in operation:
automatically generating hyper-personalized offers to users and intelligent recommendations to restaurants;
analysing the activity log of user activity data including analysing the activity log of user food consumption activity data;
determining preferences for users include food, location, language and time preferences for users;
recommending spatial locations including at least one restaurant;
sending recommendations for requests to a device associated with the spatial location including sending recommendations for specials to a restaurant device; and
generating an offer including generating a hyper-personalized curated offer.

11. The system of claim 10, wherein the machine learning arrangement, when in operation, predicts interests in the items of the proximal users based on interests of other similar users, when the activity log is not sufficiently detailed.

12. The system of claim 10, wherein the machine learning arrangement, when in operation using the machine learning to generate the recommendations for the restaurants on pricing, pictures of the menu items, and wording of offers based on the responses to the offers.

13. A method for (of) operating the system of claim 1 to generate offer and recommendation information, wherein the system includes a machine learning arrangement including data processing hardware for performing data processing, and wherein the method includes:
using the machine learning arrangement to access an activity log of user activity data obtained from a plurality of sources and analyses the activity log to determine preferences of one or more users;
using the machine learning arrangement to obtain a list of one or more user devices that are associated with a spatial location of a first type A;
using the machine learning arrangement to send recommendations for requests to at least one user device of the one or more user devices associated with the spatial location of the first type A, based on the determined preferences;
using the machine learning arrangement to obtain details of items from the at least one user device associated with the spatial location of the first type A, when a promotional campaign is launched, wherein the items are chosen based on the recommendations for the requests;
using the machine learning arrangement to determine a preference of items to which a given user of the one or more users is most likely to respond, based on the given user's activity log;
using the machine learning arrangement to generate an offer that comprises items that the given user is most likely to respond to, wherein the given user is included in a selected subset of the one or more users;
using the machine learning arrangement to communicate the offers to the selected subset of the one or more users; and
using the machine learning arrangement to monitor responses to the offers from the selected subset of the one or more users to improve a determination of the offers.

14. The method of claim 13, wherein the method includes implementing a communication of data between the machine learning arrangement and user devices via a data communication network arrangement, wherein the communicated data, to improve a data security of the system, is at least one of: encrypted, obfuscated.

15. A computer program products comprising a non-transitory computer-readable storage medium having computer-readable instructions stored thereon, the computer-readable instructions being executable by a computerized device comprising processing hardware to execute aforesaid the method of claim 13.
